(19) United States
(12) Patent Application Publication
(10) Pub. No.: US 2024/0294442 A1
(43) Pub. Date: Sep. 5, 2024

(54) STABILIZED PYROPHORIC MATERIALS FOR ONBOARD HYDROGEN GENERATION BY HYDROLYSIS AND RELATED METHODS

(71) Applicant: THE TRUSTEES OF THE UNIVERSITY OF PENNSYLVANIA, Philadelphia, PA (US)

(72) Inventors: Eric DETSI, Wallingford, PA (US); Timothy LEE, Pine Brook, NJ (US); John S. CORSI, Somerville, MA (US)

(21) Appl. No.: 18/292,522

(22) PCT Filed: Jul. 15, 2022
(86) PCT No.: PCT/US2022/073800

§ 371 Date: Jan. 26, 2024

Related U.S. Application Data
(60) Provisional application No. 63/226,340, filed on Jul. 28, 2021.

(51) Int. Cl. C06B 33/02; C01B 3/06

(52) U.S. Cl. CPC C06B 33/02; C01B 3/065

(57) ABSTRACT

Hydrolysis of water-reactive nanoporous nonprecious metals to produce hydrogen fuel on-demand for non-stationary applications is a promising method to overcome infrastructural limitations associated with current hydrogen storage and delivery systems. However, the pyrophoricity of highly reactive nanoporous nonprecious metals presents a safety and stability issue. Herein we demonstrate a method to stabilize pyrophoric nanoporous nonprecious metals by using a composite pellet structure consisting of a nanoporous nonprecious metal and a highly hygroscopic material that (i) can trap and absorb high quantities of water vapor to prevent heat buildup and subsequent pyrophoric ignition from exothermic oxidation from oxygen, and (ii) can also undergo hydrolysis to produce hydrogen, thus, making it possible to suppress the pyrophoricity without sacrificing the overall hydrogen generation yield of the composite. Lithium hydroxide and lithium borohydride were investigated as two candidate hygroscopic materials for their ability to absorb water vapor.

### CROSS-REFERENCE TO RELATED APPLICATIONS

The present application claims priority to and the benefit of U.S. patent application No. 63/226,340, “Stabilized Pyrophoric Materials for Onboard Hydrogen Generation by Hydrolysis And Related Methods” (filed Jul. 28, 2021), the entirety of which application is incorporated herein by reference for any and all purposes.

### GOVERNMENT RIGHTS

This invention was made with government support under 1840672, 1845298, and 1720530 awarded by the National Science Foundation. The government has certain rights in the invention.

### TECHNICAL FIELD

The present disclosure relates to the field of hydrogen generation by hydrolysis.

### BACKGROUND

Hydrolysis of water-reactive nanoporous nonprecious metals to produce hydrogen fuel on-demand for non-stationary applications is a promising method to overcome infrastructural limitations associated with current hydrogen storage and delivery systems. However, the pyrophoricity of highly reactive nanoporous nonprecious metals presents a safety and stability issue. Accordingly, there is a need in the field for water-reactive metals that remain stable in air.

### SUMMARY

In meeting the described needs, the disclosed technology provides a composite material, comprising: a hydrolytic phase, the hydrolytic phase defining one or more features having a cross-sectional dimension in the range of from about 3 nm to about 500 nm, and the hydrolytic phase optionally having a standard reduction potential less than the standard hydrogen electrode (SHE) at 0 V vs SHE; and a hygroscopic phase.

Also provided is a vehicle, the vehicle comprising: a composite material according to the present disclosure (e.g., according to any one of Aspects 1 to 30); a supply of water; a fuel cell configured to generate electricity from hydrogen evolved from contact between the composite material and the supply of water; and a drive system, and the vehicle being configured to communicate electricity from the fuel cell to the drive system so as to propel the vehicle.

Further provided is a vehicle, the vehicle comprising: a composite material according to the present disclosure (e.g., according to any one of Aspects 1 to 30), the composite material being in communication with an amount of water, and the vehicle being configured for propulsion by combustion of the composite material with an oxidizer and/or by combustion of hydrogen evolved by reaction of the water and the composite material.

Also provided is a method, comprising: contacting a composite material according to the present disclosure (e.g., according to any one of Aspects 1 to 30) and water so as to effect evolution of hydrogen, heat, and the reaction products of the hydrolytic and hygroscopic phases.

Additionally disclosed is a method, comprising: mixing a hydrolytic phase and a hygroscopic phase so as to form a composite material according to the present disclosure (e.g., according to any one of Aspects 1 to 30).

Further provided is a vehicle, the vehicle comprising: a composite material according to the present disclosure (e.g., according to any one of Aspects 1 to 30); a supply of oxidizer (e.g., hydrogen peroxide); a combustion reaction chamber; and a payload, and the vehicle being configured to communicate thrust combustion from the combustion chamber as to propel the vehicle.

Also disclosed is a rocket propellant, the rocket propellant comprising: a composite material according to the present disclosure (e.g., according to any one of Aspects 1 to 30), the composite material being in communication with an amount of oxidizer, and the rocket propellant being configured for propulsion by combustion of the composite material with an oxidizer, the oxidizer optionally being ice or frozen hydrogen peroxide (H₂O₂) in the case of a solid fuel system, the oxidizer optionally being a gas or liquid (e.g., liquid water, liquid hydrogen peroxide) in the case of a hybrid fuel system.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIG. 1 illustrates the spontaneous ignition of a piece of nanoporous aluminum upon exposure to air (reproduced from Reference 19).

FIGS. 2A-2C provide (FIG. 2A) Typical XRD showing Al₃₀Mg₇₀ before dealloying and NP-Al after dealloying; (FIG. 2B) Typical EDX spectrum of Al₃₀Mg₇₀ before dealloying; (FIG. 2C) Typical EDX spectrum of NP-Al after dealloying. (Al PDF #01-085-1327, Mg PDF #00-004-0770, Al₁₂Mg₁₇ PDF #01-073-1148).

FIGS. 3A-3B provide typical scanning electron micrographs of hierarchical nanoporous aluminum at (FIG. 3A) low and (FIG. 3B) high magnification.

FIGS. 4A-4B provide (FIG. 4A) typical gas chromatography peak results showing intensity of hydrogen gas detected and (FIG. 4B) Typical hydrogen generation from NP-Al 100 wt % pellet piece with results from GC shown at t=1, 3, and 5 hours (dark gray, red, and blue respectively).

FIGS. 5A-5B provide schematic representations of (FIG. 5A) pyrophoric NP-Al exposed to air where large surface area and high heat from massive oxidation via oxygen causes material to spontaneously ignite on fire and (FIG. 5B) hygroscopic effect of LiBH₄ absorbing and trapping water vapor and preventing massive oxidation of NP-Al via oxygen.

FIGS. 6A-6C provide (FIG. 6A) in situ mass change of LiOH and LiBH₄; (FIG. 6B) Visual transformation of LiBH₄ during 20 minutes of ambient air exposure; (FIG. 6C) Visual pictures of LiOH during 20 minutes of ambient air exposure.

FIG. 7 illustrates XRD transformation of hygroscopic LiBH₄ over time when exposed to ambient air. Times listed represent accumulated time when sample is “open,” and sample is “closed” using Kapton tape when running XRD to prevent accumulation of water vapor (inset).

FIGS. 8A-8B provide (FIG. 8A) NP-AI/LiOH 80:20 wt. % pellet and (FIG. 8B) NP-Al/LiBH₄ 80:20 wt. % pellet after initial exposure in ambient air.

FIG. 9 illustrates exposure of NP-Al/LiBH₄ composite pellets in ambient air at different time intervals.

FIGS. 10A-10B provide (FIG. 10A) XRD of pure NP-Al, commercial LiBH₄, and NP-Al/LiBH₄ 80:20 composite pellet (Al PDF #01-085-1327, LiBH₄ PDF #01-081-9180); (FIG. 10B) Gas chromatography of NP-Al/LiBH₄ 80:20 and 90:10 wt % composite pellets.

FIGS. 11A-11D provide (FIG. 11A) SEM of NP-Al/LiBH₄ 80:20 composite pellet; (FIG. 11B) SEM of NP-Al/LiBH₄ 90:10 composite pellet; (FIG. 11C) SEM of NP-Al/LiBH₄ 80:20 showing nanoscale pores; (FIG. 11D) EDX spectrum of NP-Al/LiBH₄ 80:20 composite pellet.

FIG. 12 provides GC results of NP-Al/LiBH₄ 80:20 wt % composite pellet over 22 hours.

FIG. 13 provides an example of a hybrid rocket propellant. In this non-limiting example, the NP-Al/LiBH₄ composite is used as the solid fuel, and liquid H₂O₂ as the oxidizer. The oxidizer flows through a catalyst where it spontaneously decomposes into oxygen gas and liquid water or vapor. This water reacts with a fraction of NP-Al and with LiBH₄ to produce hydrogen gas by hydrolysis. This hydrogen then reacts with the oxygen gas by combustion; Another fraction of the oxygen gas reacts through combustion with NP-Al.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints (e.g., “between 2 grams and 10 grams, and all the intermediate values includes 2 grams, 10 grams, and all intermediate values”). The endpoints of the ranges and any values disclosed herein are not limited to the precise range or value; they are sufficiently imprecise to include values approximating these ranges and/or values. All ranges are combinable.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

### Introduction

Hydrogen (H₂) generation from water has been the subject of intense research. The increasing demand for lightweight non-stationary energy generation systems has promoted considerable interest in H₂ as a clean-burning fuel in proton-exchange membrane (PEM) fuel cells for mobile applications such as drones and electric vehicles. But despite the very high gravimetric energy density of 33.3 kWh/kg (lower heating value) of H₂ and its high abundance in nature in the form of water, H₂ is not widely used as an energy carrier to convert chemical energy into electricity for non-stationary applications. This is partly because H₂ is a low-density gas, which takes up a large amount of space under standard conditions. Consequently, H₂ is commonly used for example in compressed cylinder tanks (350-700 bar) for commercial fuel cell vehicles and civilian drones. However, the use of pressurized H₂ tanks for mobile applications raises two major concerns:
(a) Lack of H₂ infrastructure: currently there are only ˜49 H₂ refueling stations in the U.S., most of which are located in the state of California. This makes H₂ use for non-stationary applications relatively inaccessible for most U.S. users outside of the state of California.
(b) Safety concerns: compressed H₂ gas is currently the most common form of H₂ storage due to its acceptable storage capacity (in the range of ˜5 wt. % under 350-700 bar) and technical simplicity as a mechanical-based storage method, compared to material-based storage methods. However, there are safety concerns including potential physical hazards (e.g., fire, explosion) associated with a highly-pressurized and flammable compressed gas. These safety concerns can also negatively affect public perception on H₂ technologies.

An alternative solution to high-pressure H₂ tanks is solid-state H₂ storage in lightweight materials including chemical hydrides such as magnesium hydride (MgH₂), aluminum hydride (AlH₃), lithium borohydride (LiBH₄), and sodium borohydride (NaBH₄), which can release H₂ upon heating. However, these chemical hydrides suffer from poor H₂ adsorption/release kinetics under practical temperatures and pressures, and a lack of practical regeneration methods.

An alternative to high-pressure H₂ tanks is H₂ generation by metal hydrolysis, during which a reactive metal like Al, Mg, or Zn spontaneously reacts with water to generate H₂, heat, and the corresponding metal hydroxide as the only solid byproduct. The typical hydrolysis reactions for Al, Mg and Zn are given in Eq. 1-3 with ΔG calculated at 298 K:

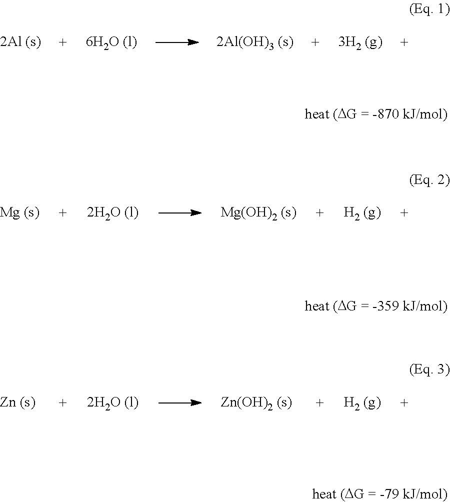

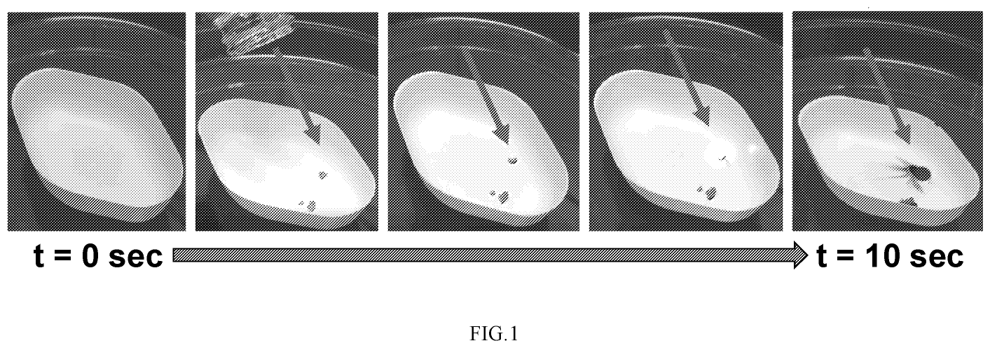

While the hydrolysis reactions in Eq. 1-3 are thermodynamically favorable, in practice these reactions can only proceed spontaneously in pure water if the metals are in a nearly oxide-free, nanostructured form. One interesting method of creating nanostructured metals is through dealloying, where a sacrificial metal component is selectively removed from a parent alloy. This typically results in a nanoporous structure of the remaining metal component. In recent years, many researchers have found innovative ways of creating nanoporous nonprecious metallic structures while preventing oxidation from air or aqueous solvents on the surface, resulting in nanoporous Al, nanoporous Mg, and nanoporous Zn. Furthermore, recent studies have shown that H₂ in high quantities can be produced by hydrolysis of these nonprecious nanoporous metals in pure water, i.e., water without addition of any co-catalysts to drive the reaction. The high surface area from having nanostructured thin ligaments in these nonprecious nanoporous metals is critical in overcoming low reaction yields associated with the metal hydroxide passivating layer that naturally forms on the metal surface during the hydrolysis reaction which prevents further reaction between water and the metal underneath the passivating layer; such a high surface area resulting from these thin nanoscale ligaments will allow for a majority of the metal to react with water. Thus, it is possible to overcome the infrastructural and safety issues associated with high-pressure H₂ tanks using nonprecious nanoporous metals like nanoporous Al, Mg, or Zn to produce H₂ onboard by hydrolysis, provided these nanoporous metals can be safely supplied to end-users through common ground-based distribution channels. Indeed, while nanostructured metals like Al, Mg, and Zn have high chemical reactivity-which is desirable for H₂ generation by hydrolysis—they are also pyrophoric and can spontaneously ignite if exposed to air. For example, Al nanoparticles with diameters less than 68 nm are pyrophoric, i.e. ignite without appreciable pre-heating. Similarly, pieces of bulk nanoporous Al spontaneously ignite when exposed to air as shown in FIG. 1 reproduced from reference 19. This is because these bulk pieces of nanoporous Al consist of nanoscale ligament/pore structures with sizes in the range of 10-20 nm, which make them highly pyrophoric.

It is therefore necessary to suppress the pyrophoricity of these water-reactive nanoporous metals. Alkali metals such as Na can also spontaneously react with water to produce H₂ but they are also highly pyrophoric. A common approach to suppress the pyrophoricity in these alkali metals is by infiltrating them (in the liquid form) into silica gel. This approach has been used by SiGNa Chemistry Inc. to develop air stable Na-based materials known as Sodium silica gel II used to generate H₂ for fuel cell applications. While this Sodium silica gel II is commercially available from Millipore-Sigma, its practical gravimetric capacity is relatively low however at 2.5-3 wt. %. This low gravimetric capacity is mostly caused by the mass of silica gel; the content of alkali metal in the sodium/silica gel mixture is only 35 wt. %, meaning that the remaining 65 wt. % is a “dead” or inactive mass.

In our present work, we propose an innovative method to suppress the pyrophoricity in water-reactive nanoporous metals without lowering the overall gravimetric capacity of the material system. Here we use nanoporous Al (NP-Al) in combination with LiBH₄ in the form of a physical pellet. The former (NP-Al) can produce H₂ by hydrolysis with pure water, but it is highly pyrophoric. The latter (LiBH₄) is a water-absorbing, highly hygroscopic, and deliquescent material. More importantly, LiBH₄ is not a “dead” mass: it can also produce H₂ upon hydrolysis with pure water through the reaction in Eq. 4 with lithium metaborate (LiBO₂) as the only solid byproduct, and with ΔG calculated at 298 K. A similar reaction producing lithium metaborate hydrate (LiBO₂·2H₂O) when the reaction occurs at relatively lower temperatures is also possible as shown in Eq. 5. Therefore, the pellets in theory are 100% active mass because of the ability for LiBH₄ to undergo hydrolysis in water. However, literature reports suggest that the kinetics of the hydrolysis of pure LiBH₄ is sluggish at room temperature and can proceed with acceptable rates and yields when heated; this includes the heat produced from the exothermic hydrolysis reaction. In a NP-Al/LiBH₄ composite pellet, one can attain a synergistic effect between the hydrolysis of NP-Al and LiBH₄. Typically, one can expect that the large amount of heat generated from the hydrolysis of NP-Al will dissipate in LiBH₄ and enhance the hydrolysis of LiBH₄ as well. Furthermore, the LiBO₂·2H₂O byproduct has been shown to be slightly basic when dissolved in water, which (without being bound to any particular theory or embodiment) can enhance the hydrolysis of aluminum via the breakdown of aluminum hydroxide or oxide passivating layers. Thus, a user can select a hygroscopic material (e.g., LiBH₄, NaBH₄, KBH₄, LiAlH₄, LiH, NaH, and/or KH) that itself reacts with water to produce hydrogen. This can give rise to a synergistic effect in which both the hydrolytic phase and the hygroscopic phase evolve hydrogen. This effect can be of particular use in vehicles where weight is critical, as a composition that evolves hydrogen from a hygroscopic phase thus has less “dead” weight than an composition that does not include such a hygroscopic phases.

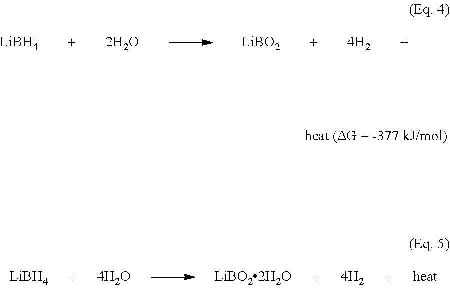

We show that mixing pyrophoric NP-Al powder with a highly hygroscopic material will nullify the combustion hazards associated with NP-Al via the accumulation of water vapor in the hygroscopic material to the point of deliquescence. Thus, the resulting composite is air-stable and usable to generate hydrogen fuel. The composite mixture is also packed into pellets which can be used as fuel in practical on-board or nonstationary applications.

### Results and Discussion

Synthesis of Nanoporous Aluminum for Hydrogen Generation by Hydrolysis with Pure Water

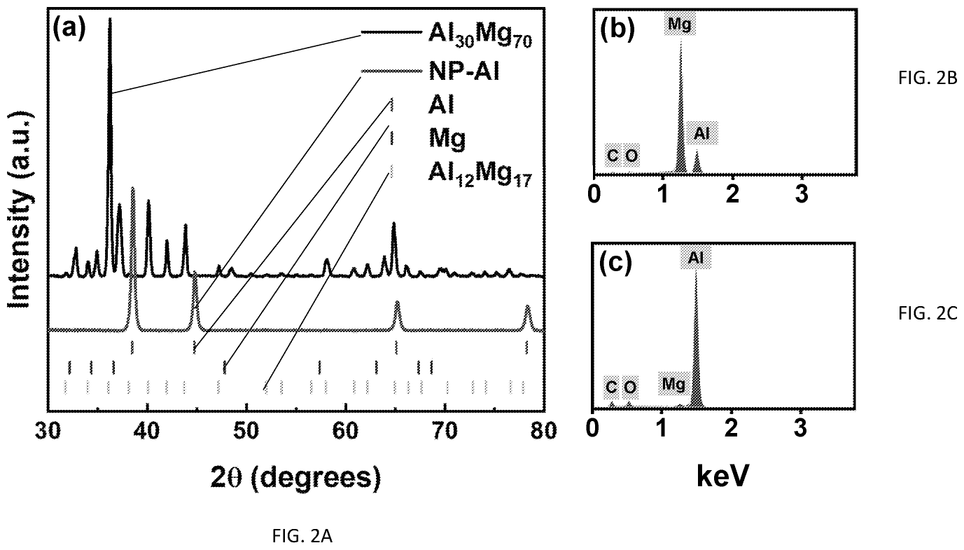

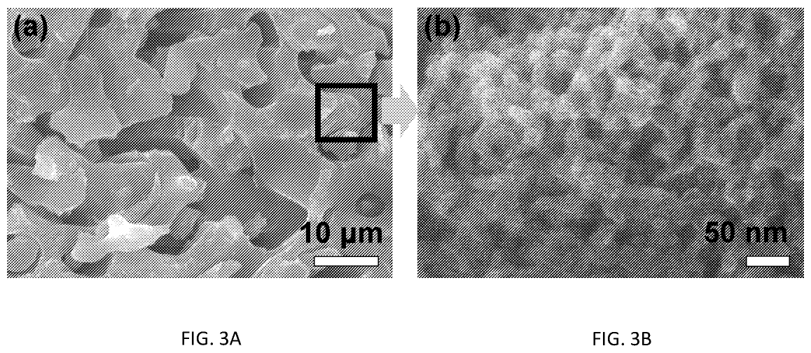

In this work, we use the air-free electrolytic dealloying method developed by Corsi et al. to make nearly oxide-free NP-Al with ultra-small ligament/pore structure. During air-free electrolytic dealloying, sacrificial Mg is electrolytically removed from an Al-Mg parent alloy with nominal composition Al₃₀Mg₇₀ at. %. FIG. 2a shows the typical X-ray diffraction (XRD) data of our Al₃₀Mg₇₀ parent alloy before dealloying (black) and after dealloying (red). According to the Al-Mg phase diagram, the phases present in this parent alloy are the Al₁₂Mg₁₇ intermetallic and (Mg) solid solution. Removal of Mg from these two phases will result in only the face-centered cubic Al phase (red curve in FIG. 2a). FIGS. 2B-2C show the typical energy dispersive X-ray spectroscopy (EDX) of the Al₃₀Mg₇₀ before and after dealloying. It can be seen that the strong Mg signal before dealloying (FIG. 2B) has nearly fully vanished after dealloying (FIG. 2C). Electrolytic removal of Mg from the Al₃₀Mg₇₀ parent alloy creates hierarchical NP-Al with large ligament/pore structure in the range of ˜1-5 μm (FIG. 3A) and ultra-small ligament pore structure in the range of ˜10-20 nm (FIG. 3B). Typically, Mg removal from the Al₁₂Mg₁₇ intermetallic phase creates the small pores, while Mg removal from the (Mg) solid solution phase creates the large pores.

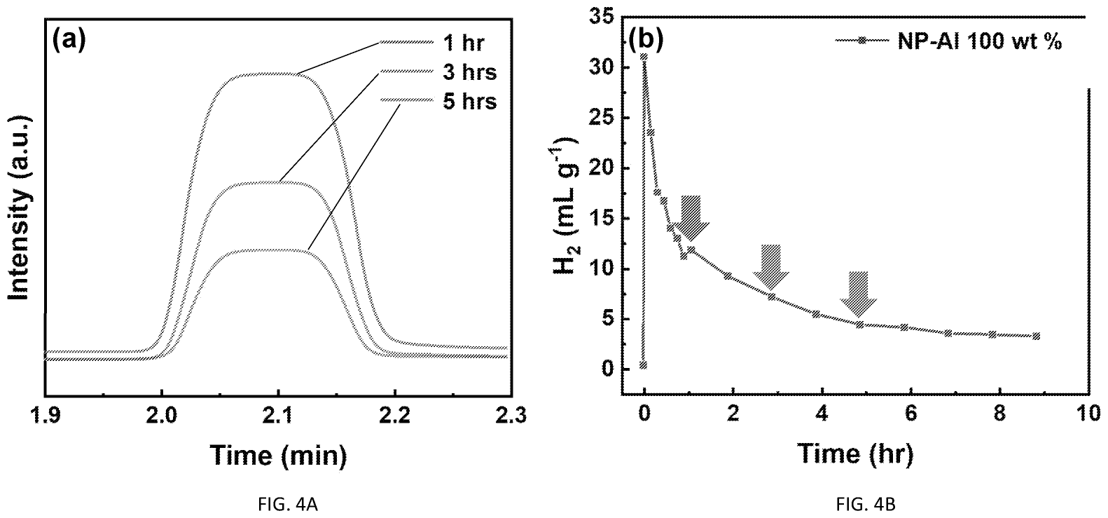

NP-Al can react with pure water to produce H₂ at ambient temperature and pressure provided it is nearly oxide-free and the ligament/pore structures are ultra-small, ideally around ˜8 nm, to compensate for the self-limiting aluminum hydroxide blocking layer formed at the reaction interface that slows down the hydrolysis reaction. The use of pure water (instead of e.g., an alkaline solution) to produce H₂ by metal hydrolysis is attractive because PEM fuel cells produce electricity from the reaction of oxygen (O₂) and H₂, with pure water as the only waste product. Thus, the wastewater from the PEM fuel cell could be collected and used to produce H₂ onboard by metal hydrolysis, reducing the mass of water that needs to be externally supplied to the system. In the present work, because the resulting nanoscale ligaments are on the scale of ˜10-20 nm, our NP-Al can produce H₂ with a high yield upon reaction with pure water (here we used deionized (DI) water) as shown in FIGS. 4A-4B, where the amount of H₂ released is measured using gas chromatography (GC). The NP-Al tested here is a bulk piece with mass ˜20 mg broken from a pellet of 100 mg of pure NP-Al. The large initial spike of H₂ shown in FIG. 4b is a result of the hydrolysis reaction between NP-Al and water near the surface of the bulk piece of NP-Al. H₂ is further generated at a relatively slower rate when water penetrates deeper into the bulk piece of NP-Al over time. Typically, ˜4.06 mL of H₂ per gram of NP-Al is measured within the first 5 hours of the hydrolysis reaction (blue arrow). Further discussion on the H₂ generation properties of this sample is provided elsewhere herein.

### Using Hygroscopicity to Suppress Pyrophoricity

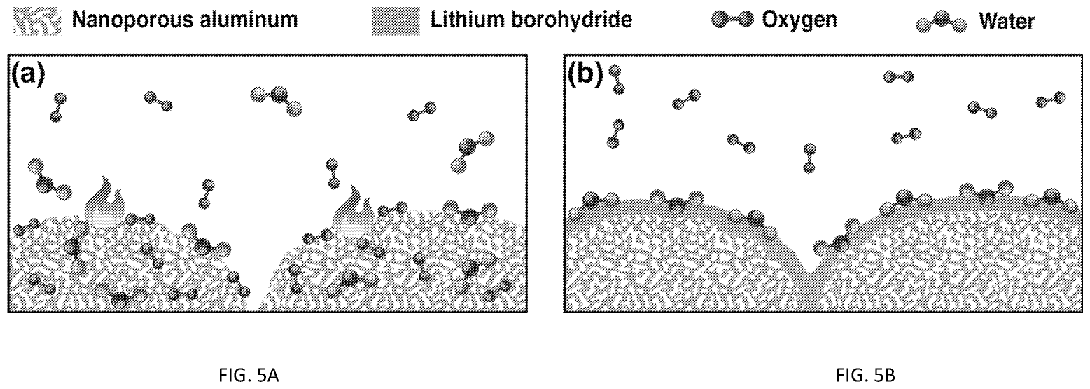

While the high reactivity of NP-Al is desirable to spontaneously produce H₂ by hydrolysis with water, it can be dangerous since NP-Al spontaneously ignites when exposed to air as shown in FIG. 1. Typically, when the very high specific surface area of the NP-Al comes in contact with O₂ from air, it generates large amounts of heat from Al oxidation to the point of self-ignition, which is further fueled by H₂ gas produced from the reaction of the NP-Al surface with water vapor from air. Thus, O₂ and water vapor from air are critical for self-ignition. We hypothesize that using a composite material consisting of a highly pyrophoric phase (e.g., NP-Al) and a highly hygroscopic phase (e.g., LiBH₄) will prevent self-ignition when the highly hygroscopic phase preferentially absorbs and “traps” water vapor from air even to the point of deliquescence. Furthermore, due to the limited solubility of O₂ in water (e.g., <10 ppm), the deliquescent LiBH₄ will restrict the amount of O₂ molecules that come into direct contact with the NP-Al to oxidize the NP-Al surface and generate heat (FIGS. 5A-5B). In other words, we can use water to prevent self-ignition of NP-Al. While water and metals can react to undergo hydrolysis, the use of water in preventing or suppressing metal fires has been done before in industrial applications. Here we propose using water vapor in air accumulated via hygroscopicity to have two roles for suppressing pyrophoricity: (1) the high specific heat capacity of water can cause absorbed water vapor to act as a heat sink and dissipate heat from the exothermic oxidation reaction of NP-Al, and (2) the absorbed layer of water from the hygroscopic material can prevent contact between NP-Al and O₂ and thus prevent massive oxidation. In this work, two different hygroscopic materials of interest, lithium hydroxide (LiOH) and LiBH₄, were investigated to be used as a composite with NP-Al due to these materials having hygroscopic properties and low molar masses. The second filler material, LiBH₄, is not only highly hygroscopic but also undergoes deliquescence in ambient air and can serve as an active filler material via Eq. 4 shown above. We also chose to use LiBH₄ over other studied deliquescent hygroscopic borohydrides such as NaBH₄ due to the lower molecular weight and thus higher H₂ capacity, though it should be understood that the illustrated use of LiBH₄ is exemplary only and non-limiting. A schematic illustrating this mechanism is shown in FIG. 5 using LiBH₄ as a hygroscopic material example. When LiBH₄ is not present in FIG. 5A, O₂ from air is able to react with the material and oxidize the surface, causing high heat accumulation to the point of self-ignition. However, when LiBH₄ is present in FIG. 5b, water vapor is preferentially absorbed which prevents massive contact with O₂ and thus prevents self-ignition.

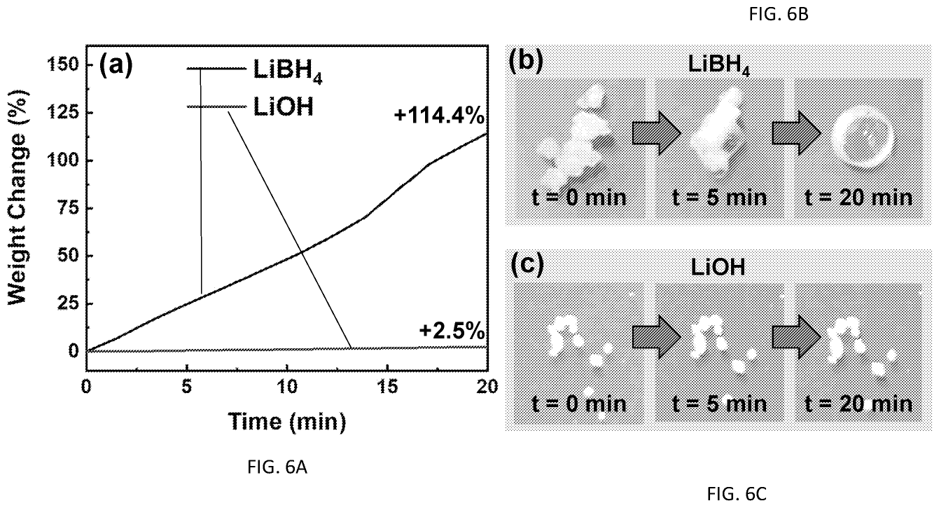

The hygroscopicity of LiOH and LiBH₄ were further investigated by in-situ gravimetric weight change measurements when exposed to ambient air as shown in FIG. 6. The source of weight change noticed in FIG. 6a is a result of water vapor “trapped” on the solid materials. In the case of LiBH₄ the increase in weight is an additional 114.4% after 20 minutes (black curve FIG. 6A), and accumulated water can be observed visually within the first 5 minutes as shown in FIG. 6B. After 20 minutes, a large water bubble is formed on LiBH₄.

Hydrolysis of LiBH₄ with accumulated water vapor will eventually proceed through Eq. 4 or Eq. 5 as explained above. Studies involving sodium borohydride (NaBH₄) have also reported on similar hydrolysis reactions occurring when NaBH₄ is exposed to air. Meanwhile, in the case of LiOH, the increase in weight is 2.5% (red curve FIG. 6A), and no visible activity or transformation is observed on LiOH as shown in FIG. 6c. Thus, although LiOH is known as a hygroscopic material, it is not as hygroscopic as LiBH₄ based on its weight change in the relevant timescale. Therefore, in relation to our hypothesis (though without being bound to any particular theory or embodiment), one may expect LiBH₄ to be more effective in preventing pyrophoricity than LiOH when initially exposed given the varying degree of hygroscopicity measured and observed.

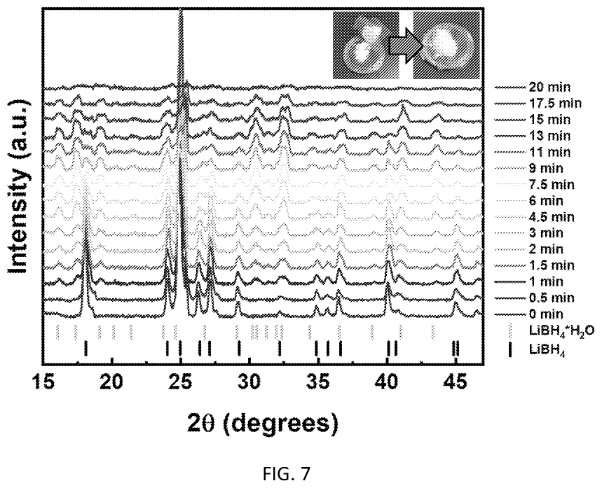

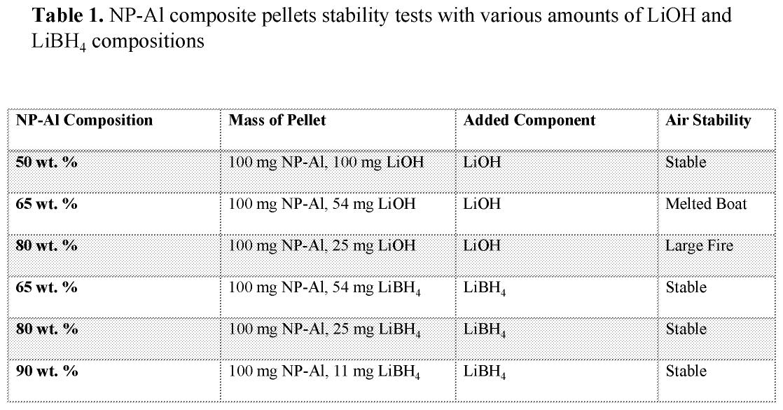

Next, the hygroscopic behavior of LiBH₄ was further investigated using sequential X-ray diffraction (XRD) techniques to track the evolution of the crystal structure of LiBH₄ within the first 20 minutes of air exposure as shown in FIG. 7. During sequential XRD, the XRD spectrum of the LiBH₄ sample is collected while this sample is protected with Kapton tape to limit its ability to absorb water. After the XRD spectrum is collected, the sample is “unsealed” by lifting the Kapton tape to expose the sample to air, enabling it to absorb water vapor for a short time. Then, the sample is “sealed” and protected with Kapton tape and a new XRD spectrum is collected (see FIG. 7 inset). The process is repeated over many cycles, and the exposure time is limited to match the exposure time from gravimetric analysis in FIG. 6A. According to our sequential XRD results, the starting LiBH₄ peaks gradually convert into LiBH₄·H₂O in ambient air; this is in agreement with other literature results studying LiBH₄ deliquescence and LiBH₄·H₂O. Theoretically, conversion from LiBH₄ into LiBH₄·H₂O represents a 183% mass increase based on the molecular weight change from adding H₂O to the chemical formula. From FIG. 6A, this corresponds to a time of 15 minutes to reach the 183% mass increase. Similarly, full XRD transformation is observed at 15 minutes of ambient air exposure for LiBH₄ into LiBH₄·H₂O. Upon further air exposure (after 15 minutes), the peaks disappear as the sample begins to undergo deliquescence and dissolve into an amorphous, liquid state like in FIG. 6b. Thus, this XRD analysis showing a phase change from crystalline LiBH₄ into amorphous LiBH₄·H₂O corroborates the presence of water in preventing pyrophoricity.

### Demonstration of Pyrophoricity Suppression:

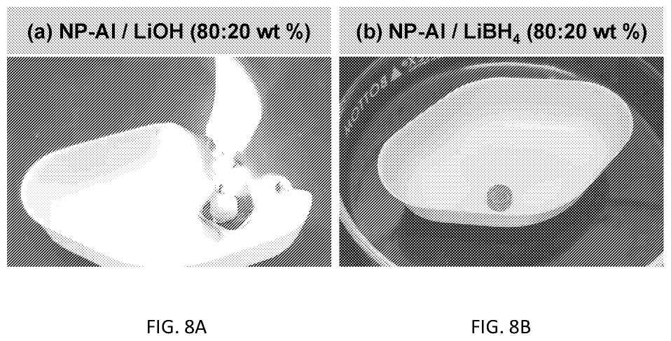

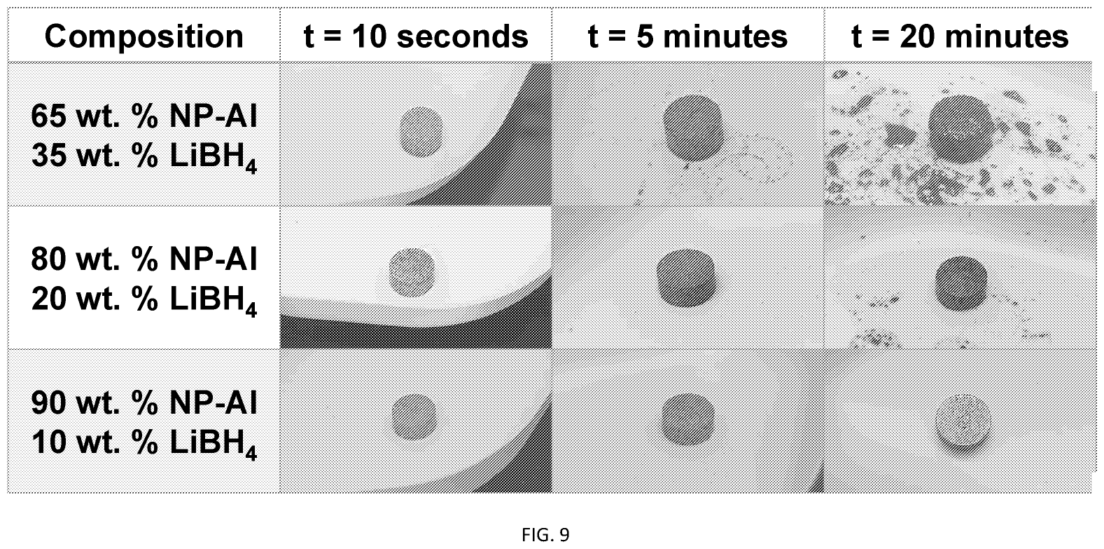

A set of three NP-Al/LiBH₄ composite pellets were created by uniformly mixing NP-Al in the powder form with LiBH₄ also in the powder form in an argon filled glove box (<0.1 PPM H₂O and O₂) and pressing the corresponding powder mixture into pellets using a 15T compact hydraulic pellet press (MTI Corp.) inside the glove box (pressed by hand at <10 bar). A set of three NP-Al/LiOH composite pellets were also created in a similar way. The amount of NP-Al in each pellet was fixed to 100 mg, and the amount of LiBH₄ or LiOH was varied. An overview between the mass ratio between NP-Al and LiBH₄ and between NP-Al and LiOH is shown in Table 1 (attached hereto). Each of the six pellets were stored in scintillation vials inside the glove box, then taken outside the glove box to test air stability by simple exposure in ambient air. Results are shown in FIGS. 8A, 8B, and 9. In the case of LiOH, when using a composite pellet with a NP-Al/LiOH ratio of 50:50 wt. %, no reaction in air is observed. However, at NP-Al/LiOH ratios of 65:35 and 80:20 wt. %, the fuel pellets are no longer air-stable and safe as they can melt and stick to the polystyrene weigh boat (from generating heat) or start a large fire as shown in FIG. 8A. Meanwhile, in the case of LiBH₄, all pellets with varying compositions of LiBH₄ between 10-35 wt. % present no initial combustion or heat generation with 20 wt. % shown as an example in FIG. 8b indicating a higher degree of air stability and safety. From these tests, we chose to use and further explore LiBH₄ as an effective pyrophoricity inhibitor compared to LiOH.

Visual photographs of the air stability of NP-Al/LiBH₄ pellets over time are shown in FIG. 9. When using the NP-Al/LiBH₄ ratio of 65:35 wt. %, the deliquescence effects of LiBH₄ can be noticed by the presence of water and bubbles at the surface of the pellet as early as 5 minutes and much more drastically at 20 minutes in ambient air. Moving the pellet around the weigh boat even sheds some of the water and composite material from the pellet due to the deliquescence. Similar deliquescence can be seen in the pellet with NP-Al/LiBH₄ ratio of 80:20 wt. % albeit at a lesser degree at 20 minutes, while the pellet with NP-Al/LiBH₄ ratio of 90:10 wt. % shows no signs of deliquescence or heat generation at any time frame. This makes the 90:10 wt. % pellet a considerable choice for air-safe H₂ fuels due to the lowest amount of LiBH₄ used while maintaining a non-pyrophoric pellet. Meanwhile, using the 80:20 wt. % pellet can have the additional practical benefit in packaging and delivering by providing a visual indicator without significant pellet breakdown if accidental air exposure may occur during transport. For these reasons, both the NP-Al/LiBH₄ 80:20 wt. % and 90:10 wt. % pellets were chosen for further characterization and analysis.

### Characterization of the Air Safe NP-Al/LiBH₄ Composite Pellets

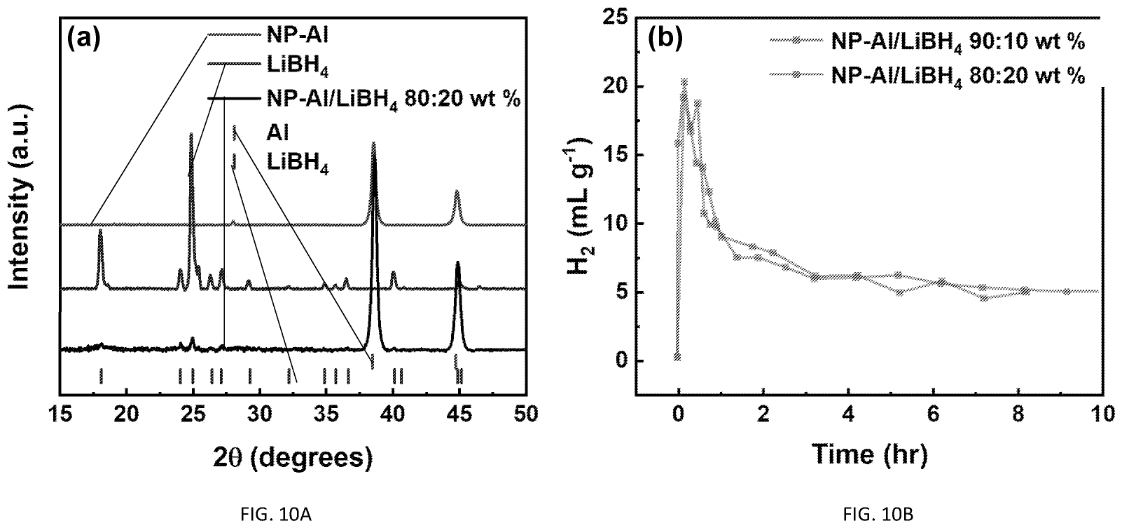

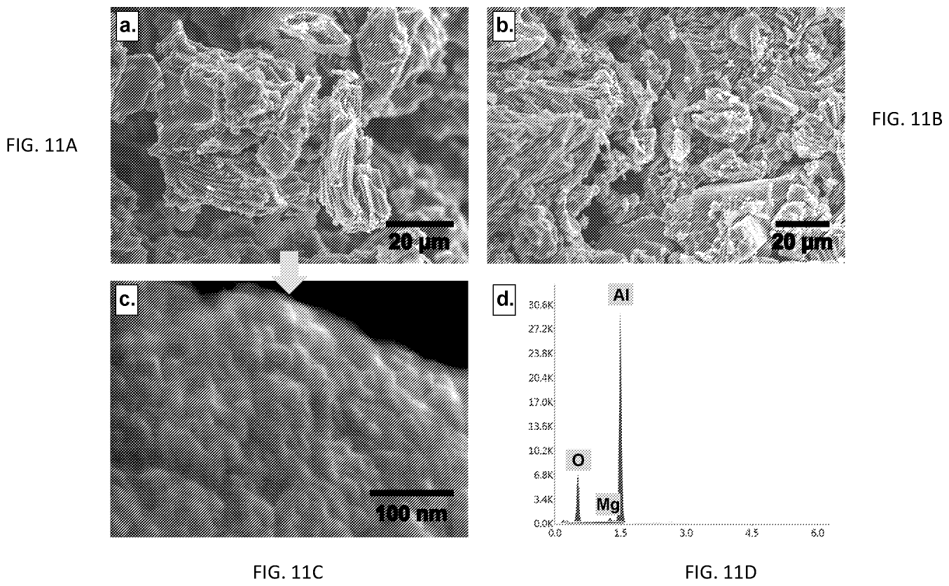

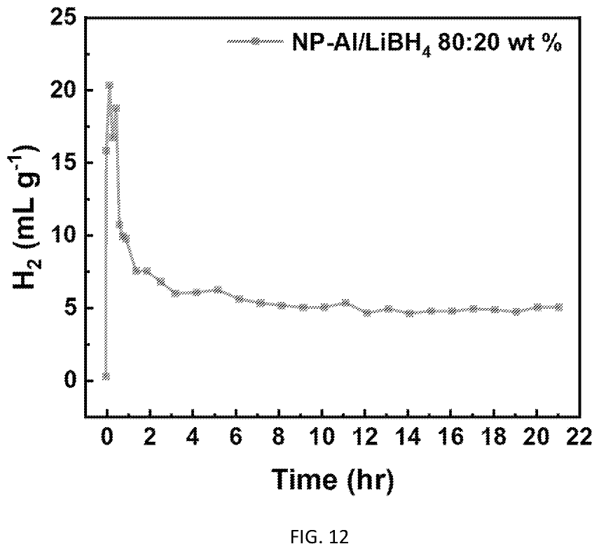

The microstructure, crystal structure, and H₂ generation behavior of the NP-Al/LiBH₄ pellets with composition 80:20 and 90:10 wt. % were further investigated. Typical data are shown in FIG. 10 and in FIG. 11. Because Li, B, and H do not appear in EDX, we mainly use XRD characterization to show the composition of the pellets. XRD characterization shows that both LiBH₄ and NP-Al phases are present in the 80:20 wt. % composite sample in FIG. 10A, although the peaks for LiBH₄ are not as strong given the low quantity of LiBH₄ present in the pellet. No chemical transformation is observed by XRD during the pellet formation process indicating only a physical mixing occurs. The H₂ generation curves via hydrolysis were measured using GC as shown in FIG. 10B. A relatively constant H₂ generation rate is detected after the initial 2.5 hours of hydrolysis. For these experiments, the pellets were broken into 4-5 bulk pieces by tapping with a spatula, and hydrolysis took place on a single compacted piece of ˜20 mg. We found 6.01 mL H₂ produced per gram NP-Al/LiBH₄ within 5 hours of submersion for the 80:20 wt. % composition pellet and 4.72 mL H₂ produced per gram NP-Al/LiBH₄ for the 90:10 wt. % composition. Since a single piece is tested, the expected H₂ generation curve as a function of time is expected to be different from our previous experiments using nanoporous metals crushed into fine, free-flowing powders for H₂ gas generation because of the differing surface areas available between free-flowing powder form and compact pellet form.¹⁹⁻²¹ Thus, a low amount of H₂ is released and observed initially from these pellets; however, a longer and steady H₂ generation rate can be achieved as shown in FIG. 12, where 4.81 mL H₂ per gram is detected after 21 hours of submersion for the NP-Al/LiBH₄ 80:20 wt. % pellet. The prolonged, near-steady H₂ generation is a result of the compressed pellet form factor that reduces the total surface area available for reaction with water and represents the speed in which water can penetrate deeper into the pellet. Therefore, we expect altering the size and form of the pellets to be able to change the hydrogen generation rate to other values as desired to be used as fuel.

### CONCLUSION

Nanoporous nonprecious metals created by dealloying can be used to generate H₂ fuel via metal hydrolysis with pure water. However, these highly reactive nanoporous nonprecious metals are also highly pyrophoric—a double-edged sword that can limit its practical usage and applications due to safety and stability concerns if improperly exposed to air. Thus, we present a new strategy to suppress pyrophoricity in nanoporous metals by forming composite pellets with hygroscopic materials. Nanoporous aluminum was created via air-free electrolytic dealloying and shown to produce H₂ when reacted with pure water at room temperature and pressure. Two hygroscopic materials—LiOH and LiBH₄—were combined with this nanoporous aluminum in various quantities and pressed into pellets. The main effect of these hygroscopic materials was shown to be the accumulation of water vapor at the surface of the material with LiBH₄ showing much higher affinity and accumulation of water vapor to the point of deliquescence via additional in-situ weight and sequential XRD measurements. Composite pellets of nanoporous aluminum and LiBH₄ in all compositions analyzed (NP-Al/LiBH₄ 65:35, 80:20, and 90:10 wt. %) were not pyrophoric when exposed to ambient air, while composite pellets containing NP-Al/LiOH 65:35 and 80:20 wt. % still generated heat or spontaneously ignited. Furthermore, H₂ generated from these composite pellets showed steady hydrogen generation rates for long hours that could be used to supply H₂ for non-stationary onboard applications or devices.

### Experimental Section

Materials: Magnesium chips (Mg, 99.98%), phenylmagnesium chloride (PhMgCl, 2.0 M in tetrahydrofuran), lithium chloride (LiCl, powder, ≥99.98%), lithium hydroxide (LiOH, (powder, ≥98%), and lithium borohydride (LiBH₄, ≥95%) were purchased from Millipore-Sigma. Aluminum shot (Al, 99.9%), aluminum trichloride (AlCl₃, 99.985%), and tetrahydrofuran (THF, anhydrous, 99.8+%, butylated hydroxytoluene (BHT)-free) were purchased from Alfa-Aesar. All chemicals were used as is from suppliers and stored in an argon filled glovebox (<0.1 PPM H₂O and O₂).

Methods: NP-Al is created using our previously published procedure using air-free selective electrolytic removal of Mg from Al₃₀Mg₇₀ parent alloys in all-phenyl complex (APC) electrolyte enhanced with LiCl in an argon filled glovebox (<0.1 PPM H₂O and O₂)^{19,21} Al₃₀Mg₇₀ parent alloys were created via melting at 800° C. under argon gas using a tube furnace (MTI Corporation), and the electrolytic dealloying 0.4 M APC electrolyte was created from mixing AlCl₃, PhMgCl in THE, and LiCl in THE as per our previous publication.^{21,46} The resulting NP-Al from electrolytic dealloying is brittle and crushed using a mortar and pestle into a free-flowing powder to be mixed into pellets. Pellets containing NP-Al and varying amounts of hygroscopic additives were created using a 15T Compact Hydraulic Pellet Press (MTI Corporation) in an argon filled glovebox (<0.1 PPM H₂O and O₂) with each pellet carefully mixed and containing 100 mg active material (NP-Al) and diameter of ¼ inch. The pressure applied was <10 bar. In-situ weight measurements of hygroscopic materials were conducted using an ultra-microbalance (Perkin-Elmer AD-4 Autobalance, ±0.1 microgram resolution) and tracking weight changes every 30 seconds for ˜2 mg of sample in ambient air. X-ray diffraction (XRD) phase transformation analysis was conducted using Kapton tape (1 mil) to cover over the sample while XRD was running to limit its exposure to ambient air. Samples were then re-exposed by lifting the Kapton tape off the sample. Air-stability tests exposing composite pellets were conducted in ambient air at room temperature and pressure inside an empty fume hood (20-22° C., 25-35% relative humidity).

Instrument Characterization: A JEOL 7500F high resolution scanning electron microscope (HRSEM) with energy dispersive X-ray spectroscopy (EDS) was used to characterize the morphology of hierarchical NP-Al and in the pellet form with LiBH₄. X-ray diffraction (XRD) patterns were collected on a Rigaku Miniflex powder diffractometer, equipped with a Cu X-ray source operated at 40 kV/15 mA, theta/2theta goniometer in the Bragg-Brentano parafocusing geometry, Ni foil K-beta filter, and a 1D solid state detector. A customized Scion 456 gas chromatograph (GC) was used to quantitatively study the hydrogen production rate by hydrolysis. Pellets (>100 mg) were crushed into 4-5 pieces, and a monolithic piece typically ˜20-25 mg in mass was sealed in a three-neck round bottom flask using a rubber septum under an argon atmosphere to prevent oxidation before transferring the glassware setup to the GC. Helium carrier gas (99.9999%, Airgas) was used to flow through the system to deliver gas formed in the glassware to the GC. Deionized (DI) H₂O was sparged with argon gas for 10 minutes before injection via a syringe into the reaction flask. A pulsed discharge detector (PDD) with a molecular sieve (5A) packed column was used to quantitatively measure hydrogen produced.

### ASPECTS

The following Aspects are illustrative only and do not limit the scope of the present disclosure or the appended claims. Any Aspect or any part of any Aspect can be combined with any other Aspect or any part of any other Aspect.

Aspect 1. A composite material, comprising: a hydrolytic phase, the hydrolytic phase defining one or more features having a cross-sectional dimension in the range of from about 3 nm to about 500 nm, and the hydrolytic phase optionally having a standard reduction potential less than the standard hydrogen electrode (SHE) at 0 V vs SHE; and a hygroscopic phase.

Aspect 2. The composite material of Aspect 1, wherein the hydrolytic phase comprises one or more of a metal, an alloy, or a metalloid.

Aspect 3 The composite material of Aspect 2, wherein the metal comprises one or more of Al, Mg, Zn, Li, Na, K, Ca, Fe, Ti, Ta, Zr, Cr, Ga, Pb, Mo, or Nb.

Aspect 4. The composite material of Aspect 3, wherein the hydrolytic phase consists essentially of Al.

Aspect 5. The composite material of Aspect 2, wherein the alloy comprises one or more of Al, Mg, Zn, Li, Na, K, Ca, Fe, Ti, Ta, Zr, Cr, Ga, Pb, Mo, Sb, Ge, B, As, Se, Te, or Nb.

Aspect 6. The composite material of Aspect 2, wherein the metalloid comprises one or more of Si, Sb, Ge, B, As, Se, or Te.

Aspect 7. The composite material of any one of Aspects 1 to 6, wherein the hygroscopic phase comprises one or more of a metal borohydride, a metal hydride, a hydroxide, a chloride, a sulfate, a polymer, lithium bromide (LiBr), phosphorus pentoxide (P₄O₁₀, or P₂O₅) ammonium nitrate (NH₄NO₃), alumina (Al₂O₃), a molecular sieve, or a metal-organic framework material. A hygroscopic phase can include, e.g., LiBH₄ NaBH₄, KBH₄, LiAlH₄, LiH, NaH, and/or KH. Without being bound to any particular theory or embodiment, the hygroscopic phase can be one that evolves hydrogen from reaction with water.

Aspect 8. The composite material of Aspect 7, wherein the metal borohydride comprises at least one of lithium borohydride (LiBH₄), sodium borohydride (NaBH₄), potassium borohydride (KBH₄), magnesium borohydride (Mg(BH₄)₂), calcium borohydride (Ca(BH₄)₂), sodium cyanoborohydride (NaBH₃CN), or lithium triethylborohydride (LiBHEt₃).

Aspect 9. The composite material of Aspect 7, wherein the metal hydride comprises LiAlH₄.

Aspect 10. The composite material of Aspect 7, wherein the metal hydroxide comprises at least one of lithium hydroxide (LiOH), sodium hydroxide (NaOH), and potassium hydroxide (KOH).

Aspect 11. The composite material of Aspect 7, wherein the chloride compound comprises one or more of lithium chloride (LiCl), sodium chloride (NaCl), calcium chloride (CaCl₂)), magnesium chloride (MgCl₂), or aluminum trichloride (AlCl₃).

Aspect 12. The composite material of Aspect 7, wherein the sulfate compound comprises at least one of lithium sulphate (Li₂SO₄), sodium sulphate (Na₂SO₄), calcium sulphate (CaSO₄), magnesium sulphate (MgSO₄), copper sulphate (CuSO₄).

Aspect 13. The composite material of Aspect 7, wherein the polymer comprises one or more of carboxymethyl cellulose (CMC) and poly (methyl methacrylate) (PMMA).

Aspect 14. The composite material of Aspect 7, wherein the hydroscopic phase comprises one or more of lithium bromide (LiBr), phosphorus pentoxide (P₄O₁₀), or ammonium nitrate (NH₄NO₃).

Aspect 15. The composite material of Aspect 7, wherein the hygroscopic phase is porous and comprises one or more of activated alumina (Al₂O₃), molecular sieve (such as Na₁₂[(AlO₂)₁₂(SiO₂)₁₂]·nH₂O alkali metal aluminosilicates), and metal-organic framework materials (MOFs) (e.g., MOF-199, copper(II)-benzene-1,3,5-tricarboxylate (Cu-BTC)).

Aspect 16. The composite material of any one of Aspects 1 to 15, wherein the wt. % ratio of the hydrolytic phase to the hygroscopic phase is from about 99:1 to about 50:50.

Aspect 17. The composite material of Aspect 16, wherein the wt. % ratio of the hydrolytic phase to the hygroscopic phase is from about 98:2 to about 70:30.

Aspect 18. The composite material of any one of Aspects 1 to 17, wherein the hydrolytic phase comprises pores in the range of from 5 to about 500 nm.

Aspect 19. The composite material of any one of Aspects 1 to 18, wherein the hydrolytic phase defines a hierarchical porous morphology with a first population of pores in the range of about 3 to about 500 nm, and a second population of pores in the range of about 1 to about 10 μm.

Aspect 20. The composite material of Aspect 19, wherein the first population of pores defines a population of pores having an average cross-sectional dimension in the range of from about 3 to about 300 nm.

Aspect 21. The composite material of any one of Aspects 1 to 20, wherein the hydrolytic phase defines interconnected ligaments defining pores therebetween, the ligaments defining an average cross-sectional dimension in the range of from about 5 to about 500 nm.

Aspect 22. The composite material of any one of Aspects 1 to 21, wherein at least one of the hydrolytic phase and the hygroscopic phase comprises one or more of nanoparticles, nanorods, nanowires or nanofibers.

Aspect 23. The composite material of any one of Aspects 1 to 22, wherein the hygroscopic phase becomes deliquescent in contact with water, the hygroscopic phase optionally forming a solution that substantially restricts oxygen from contacting the hydrolytic phase.

Aspect 24. The composite material of any one of Aspects 1 to 23, wherein at least one of the hydrolytic phase and the hygroscopic phase is in particulate form.

Aspect 25. The composite material of any one of Aspects 1 to 24, wherein the composite material is in a compressed form.

Aspect 26. The composite material of any one of Aspects 1 to 25, wherein the composite material is in the form of a pellet, a shot, a pill, or a ball.

Aspect 27. The composite of any one of Aspects 1 to 26, wherein the composite material is in contact with water in liquid or vapor phase.

Aspect 28. The composite material of any one of Aspects 1 to 27, wherein the composite is disposed in a vehicle.

Aspect 29 The composite material of Aspect 28, wherein the vehicle is powered by hydrogen evolved by reaction between the composite material and water.

Aspect 30. The composite material of any one of Aspects 1 to 29, wherein the composite is disposed in a stationary power generator or a mobile power generator.

Aspect 31. A vehicle, the vehicle comprising: a composite material according to any one of Aspects 1 to 30; a supply of water; a fuel cell configured to generate electricity from hydrogen evolved from contact between the composite material and the supply of water; and a drive system, and the vehicle being configured to communicate electricity from the fuel cell to the drive system so as to propel the vehicle.

Aspect 32. A vehicle, the vehicle comprising: a composite material according to any of Aspects 1 to 30, the composite material being in communication with an amount of water, and the vehicle being configured for propulsion by combustion of the composite material with an oxidizer and/or by combustion of hydrogen evolved by reaction of the water and the composite material.

Aspect 33. A method, comprising: contacting a composite material according to any one of Aspects 1 to 30 and water so as to effect evolution of hydrogen, a heat, and a reaction product of the hydrolytic phase.

Aspect 34. The method of Aspect 33, further comprising recovering at least some of the one or both of an oxide or a hydroxide of the material.

Aspect 35. A method, comprising mixing a hydrolytic phase and a hygroscopic phase so as to form a composite material according to any one of Aspects 1 to 30.

Aspect 36. The composite material of any one of Aspects 1 to 30, wherein the composite material is disposed in a rocket propellant or projectile propellant.

Aspect 37. The composite material of Aspect 36, wherein the rocket propellant is powered by combustion of pellets as a solid fuel or with gaseous or liquid oxidizer as a hybrid fuel. Example liquid oxidizers include, e.g., liquid water and liquid hydrogen peroxide.

Aspect 38. A vehicle (e.g., a rocket), the vehicle comprising: a composite material according to any one of Aspects 1 to 30; a supply of oxidizer (e.g., hydrogen peroxide); a combustion reaction chamber; and a payload, and the vehicle being configured to communicate thrust combustion from the combustion chamber as to propel the vehicle.

Aspect 39. A rocket propellant, the rocket propellant comprising: a composite material according to any one of Aspects 1 to 30, the composite material being in communication with an amount of oxidizer, and the rocket propellant being configured for propulsion by combustion of the composite material with an oxidizer, the oxidizer optionally being ice or frozen hydrogen peroxide (H₂O₂) in the case of a solid fuel system, the oxidizer optionally being a gas or liquid (e.g., liquid water, liquid hydrogen peroxide) in the case of a hybrid fuel system.

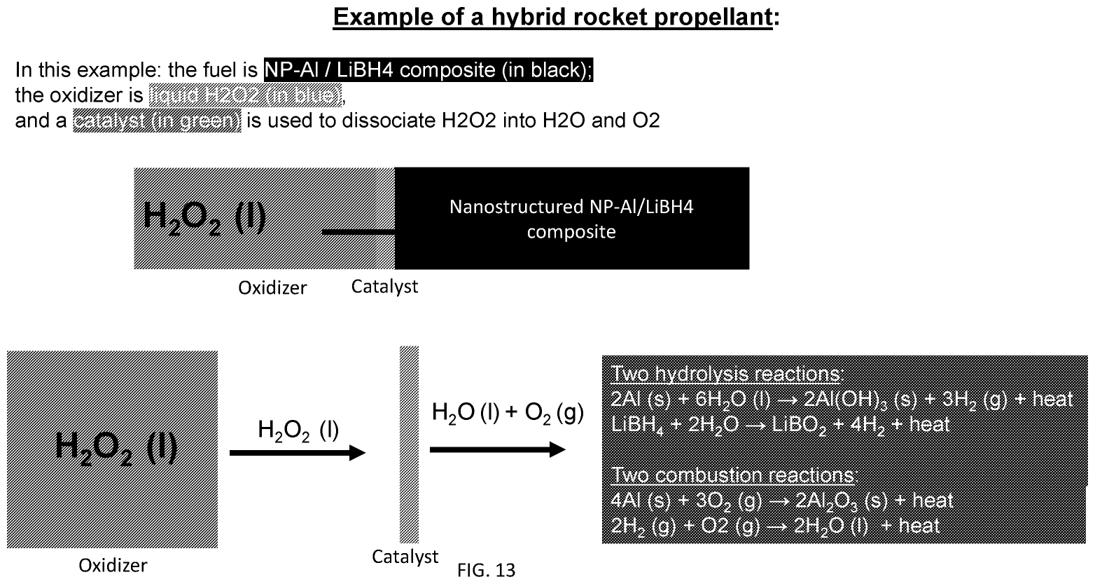

FIG. 13 provides an example of a hybrid rocket propellant. In this non-limiting example, the NP-AI/LiBH₄ composite is used as the solid fuel, and liquid H₂O₂ as the oxidizer. The oxidizer flows through a catalyst where it spontaneously decomposes into oxygen gas and liquid water or vapor. This water reacts with a fraction of NP-Al and with LiBH₄ to produce hydrogen gas by hydrolysis. This hydrogen then reacts with the oxygen gas by combustion; Another fraction of the oxygen gas reacts through combustion with NP-Al.

1. A composite material, comprising:
a hydrolytic phase,
the hydrolytic phase defining one or more features having a cross-sectional dimension in the range of from about 3 nm to about 500 nm, and
the hydrolytic phase optionally having a standard reduction potential less than the standard hydrogen electrode (SHE) at 0 V vs SHE; and
a hygroscopic phase, the hygroscopic phase optionally being reactive with water to produce hydrogen.

2. The composite material of claim 1, wherein the hydrolytic phase comprises one or more of a metal, an alloy, or a metalloid.

3. The composite material of claim 2, wherein the metal comprises one or more of Al, Mg, Zn, Li, Na, K, Ca, Fe, Ti, Ta, Zr, Cr, Ga, Pb, Mo, or Nb.

4. (canceled)

5. The composite material of claim 2, wherein the alloy comprises one or more of Al, Mg, Zn, Li, Na, K, Ca, Fe, Ti, Ta, Zr, Cr, Ga, Pb, Mo, Sb, Ge, B, As, Se, Te, or Nb.

6. The composite material of claim 2, wherein the metalloid comprises one or more of Si, Sb, Ge, B, As, Se, or Te.

7. The composite material of claim 1, wherein the hygroscopic phase comprises one or more of a metal borohydride, a metal hydride, a hydroxide, a chloride, a sulfate, a polymer, lithium bromide (LiBr), phosphorus pentoxide (P₄O₁₀, or P₂O₅) ammonium nitrate (NH₄NO₃), alumina (Al₂O₃), a molecular sieve, or a metal-organic framework material.

8. The composite material of claim 7, wherein the metal borohydride comprises at least one of lithium borohydride (LiBH₄), sodium borohydride (NaBH₄), potassium borohydride (KBH₄), magnesium borohydride (Mg(BH₄)₂), calcium borohydride (Ca(BH₄)₂), sodium cyanoborohydride (NaBH₃CN), or lithium triethylborohydride (LiBHEt₃).

9. (canceled)

10. The composite material of claim 7, wherein the metal hydroxide comprises at least one of lithium hydroxide (LiOH), sodium hydroxide (NaOH), and potassium hydroxide (KOH).

11. The composite material of claim 7, wherein the chloride compound comprises one or more of lithium chloride (LiCl), sodium chloride (NaCl), calcium chloride (CaCl₂)), magnesium chloride (MgCl₂), or aluminum trichloride (AlCl₃).

12. The composite material of claim 7, wherein the sulfate compound comprises at least one of lithium sulphate (Li₂SO₄), sodium sulphate (Na₂SO₄), calcium sulphate (CaSO₄), magnesium sulphate (MgSO₄), copper sulphate (CuSO₄).

13. The composite material of claim 7, wherein the polymer comprises one or more of carboxymethyl cellulose (CMC) and poly (methyl methacrylate) (PMMA).

14. The composite material of claim 7, wherein the hygroscopic phase comprises one or more of lithium bromide (LiBr), phosphorus pentoxide (P₄O₁₀), or ammonium nitrate (NH₄NO₃).

15. The composite material of claim 7, wherein the hygroscopic phase is porous and comprises one or more of activated alumina (Al₂O₃), molecular sieve (such as Na₁₂[(AlO₂)₁₂(SiO₂)₁₂]·nH₂O alkali metal aluminosilicates), and metal-organic framework materials (MOFs) (such as MOF-199, copper(II)-benzene-1,3,5-tricarboxylate (Cu-BTC)).

16. The composite material of claim 1, wherein the wt. % ratio of the hydrolytic phase to the hygroscopic phase is from about 99:1 to about 50:50.

17. (canceled)

18. The composite material of claim 1, wherein the hydrolytic phase comprises pores in the range of from 5 to about 500 nm.

19. The composite material of claim 1, wherein the hydrolytic phase defines a hierarchical porous morphology with a first population of pores in the range of about 3 to about 500 nm, and a second population of pores in the range of about 1 to about 10 μm.

20. (canceled)

21. The composite material of claim 1, wherein the hydrolytic phase defines interconnected ligaments defining pores therebetween, the ligaments defining an average cross-sectional dimension in the range of from about 5 to about 500 nm.

22. (canceled)

23. The composite material of claim 1, wherein the hygroscopic phase becomes deliquescent in contact with water, the hygroscopic phase optionally forming a solution that substantially restricts oxygen from contacting the hydrolytic phase.

24. (canceled)

25. (canceled)

26. The composite material of claim 1, wherein the composite material is in the form of a pellet, a shot, a pill, or a ball.

27. (canceled)

28. (canceled)

29. (canceled)

30. The composite material of claim 1, wherein the composite is disposed in a vehicle, a stationary power generator, or a mobile power generator.

31. (canceled)

32. (canceled)

33. A method, comprising:
contacting a composite material according to claim 1 and water so as to effect evolution of hydrogen, a heat, and a reaction product of the hydrolytic phase.

34. The method of claim 33, further comprising recovering at least some of the one or both of an oxide or a hydroxide of the material.

35. (canceled)

36. The composite material of claim 1, wherein the composite material is disposed in a rocket propellant or projectile propellant.

37. (canceled)

38. (canceled)

39. (canceled)
